(19) United States
(12) Patent Application Publication
(10) Pub. No.: US 2006/0082426 A1
(43) Pub. Date: Apr. 20, 2006

(54) Microwave filter comprising a coaxial structure

(76) Inventors: Dominique Lo Hine Tong, Rennes (FR); Ali Louzir, Rennes (FR); Philippe Chambelin, Chateaugiron (FR); Christian Person, Locmaria Plouzane (FR); Jean-Philippe Coupez, Le Relecq Kerhuon (FR)

Correspondence Address: THOMSON LICENSING INC., PATENT OPERATIONS, PO BOX 5312, PRINCETON, NJ, 08543-5312, US

(21) Appl. No.: 10/540,147

(22) PCT Filed: Dec. 22, 2003
(86) PCT No.: PCT/FR03/50200

§ 371 Date: Jun. 21, 2005

(30) Foreign Application Priority Data
Jun. 3, 2003 (FR) 03/00048

(51) Int. Cl. H01P 1/202

(52) U.S. Cl. 333/206

(57) ABSTRACT

The invention relates to a microwave filter comprising a coaxial structure, consisting of a tubular outer conductor and an inner bar conductor. According to the invention, the inner bar conductor extends in an axial direction inside the outer tube and, together with said tube, forms a series of concentric slots in the axial direction thereby defining successive coaxial line segments with low characteristic impedance and coaxial line segments with high characteristic impedance. The aforementioned concentric slots are produced in a synthetic foam block.

The invention relates to a coaxial structure microwave filter comprising an outer conductive core and an inner conductive core extending according to an axial direction within the outer core and forming with this core a succession of concentric crenelations according to an axial direction defining successive sections of low characteristic impedance coaxial lines and high characteristic impedance coaxial lines.

The work “Microwave Filters, Impedance-Matching Networks and Coupling Structures”, MgrawHill, 1962, describes such a microwave filter, in particular a low-pass filter, in which the outer conductive core is normally constituted by a cylindrical metal rod carrying concentric metal disks spaced according to the axial direction, the metal disks forming the succession of concentric crenelations. The cross-section of the inner core thus varies according to the axial direction so that each section of the large diameter inner core (corresponding to a metal disk) defines a section of coaxial line of very low impedance and each section of inner core of smaller diameter (corresponding to the interval between two consecutive disks) defines a section of coaxial line of high impedance. The dimensions of the sections are adjusted so as to realize the transfer function of the filter. However, the realisation of such a coaxial structure microwave filter proves to be complex and costly, particularly for maintaining a perfect coaxiality between the inner core and the outer core of the filter. Spacers made from plastic or another dielectric material are generally used to maintain the coaxiality but this introduces dielectric losses.

The invention proposes a coaxial structure microwave filter of a simpler and less expensive construction suitable for low cost volume production.

For this purpose, the invention relates to a coaxial structure microwave filter constituted by a tube of synthetic foam material, the tube presenting a constant internal diameter and a fully metallized external surface with, in the axial direction, a profile according to a periodic or constant function and by a bar of a fully metallized synthetic material, with a constant external profile or following a periodic function, the largest diameter of the bar being noticeably equal to the internal diameter of the tube so that the bar can be inserted into the tube while maintaining the coaxiality between the tube and the bar. The foam used is preferably a polymethacrylimide foam known for its electrical characteristics approaching those of air, for its mechanical characteristics of rigidity and lightness and for its low cost price. In particular, a polymethacrylimide foam commercialised under the name of “ROHACELL HF” can be used.

According to the particularities of a filter according to the invention:
The periodic or constant function per part depends on crenelations, the crenelations being able to have dimensions that differ from one crenelation to another.
The thickness of the tube is chosen to maintain electrical insulation between the metallized surface of the tube and the bar

With this construction, a microwave filter can easily be combined with a monopole type or dipole type antenna.

The invention extends to a method of producing a microwave filter as defined above according to which the periodic function is realized by thermoforming the foam tube or foam bar. In particular, as a thermoforming technique, hot press moulding will preferably be used, which is adapted to an objective of high volume, low cost production.

The metallization of the foam tube or foam bar is preferably a non-directive metallization by projection or brush.

Embodiments of a filter according to the invention are described below and illustrated in the drawings.

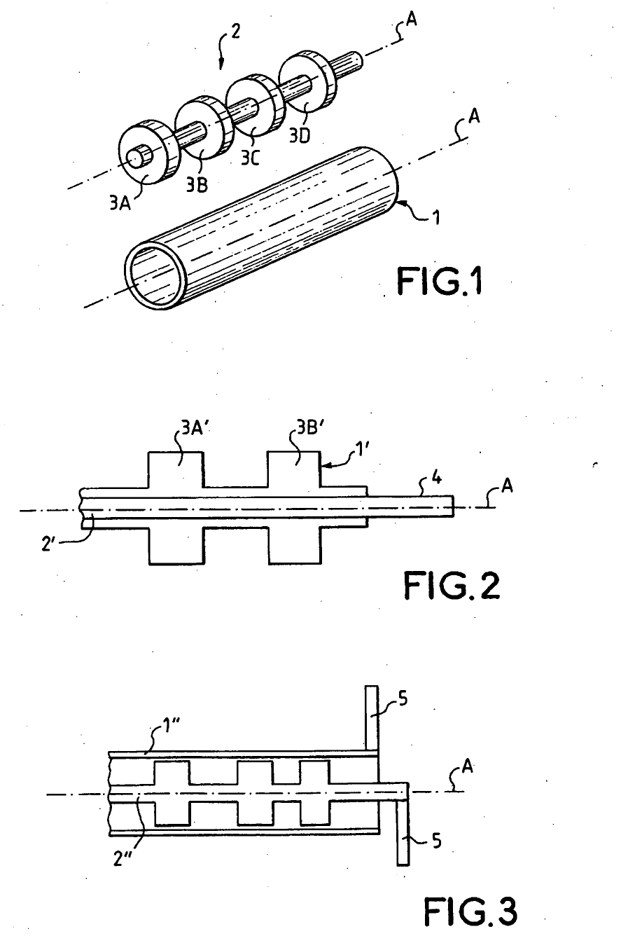

FIG. 1 shows an exploded perspective, in a highly schematic manner, of a first embodiment of a coaxial structure microwave filter according to the invention.

FIG. 2 schematically shows an axial section of a second embodiment of a coaxial structure microwave filter according to the invention associated with a monopole type antenna.

FIG. 3 schematically shows an axial section of a filter according to the first embodiment associated with a dipole type antenna.

A first example of a coaxial structure microwave filter according to the invention is shown in FIG. 1 according to an exploded perspective view.

The outer conductive tube 1 and the inner conductive bar 2 of the filter are shown in FIG. 1 dissociated from each other for greater clarity, but it must be understood that the inner bar 2 extends according to the axial direction A inside the outer tube 1.

The inner bar 2 of the filter is constituted by a cylindrical bar made of synthetic foam whose outer surface follows a periodic function according to the axial direction. It preferably forms a succession of concentric crenelations 3A to 3D realizing the transfer function of the filter, for example a transfer function of a low-pass filter by defining successive sections of low characteristic impedance coaxial lines and high characteristic impedance coaxial lines. The conformation of the foam bar 2 is realized by thermoforming, in particular according to a hot press moulding technique. The outer surface of foam bar 2 is metallized preferably by projection or by brush.

The outer tube 1 of the filter is constituted by a cylindrical tube of synthetic foam having a constant inner cross-section, the inner diameter of the tube being very slightly greater at the largest outer diameter of the foam bar 2 to allow the bar to be inserted into the tube. The cylindrical tube 1 has an outer surface fully metallized according to the technique described above. The thickness of the tube 1 is chosen to realize an electrical insulation between its outer metallized surface and the bar

The synthetic material foam used is preferably a polymethacrylate imide foam.

The structure of the filter shown in FIG. 1 can be reinforced by two half-shells (not shown) surrounding the tube 1 that can be realized in a plastic material or in synthetic foam material.

Naturally, the tube 1 and foam bar 2 can have a cross-section other than circular, for example rectangular or square without falling outside the scope of the invention.

FIG. 2 shows another embodiment of a filter according to the invention. The outer tube 1′ of the filter is constituted by a constituted by a cylindrical tube of synthetic foam material whose outer metallized surface is conformed to define the succession of crenelations 3A′-3B′ according to the axial direction A whereas the inner bar 2′ of the filter is constituted by a conductive cylindrical bar of constant cross-section. In this manner, the outer surface of the tube presents, according to the axial direction, a profile following a periodic or constant function by parts such as a crenelation function. The conductive bar 2′ can consist of a solid or hollow cylindrical metal tube. The bar 2′ can also be constituted by metallized synthetic material foam. In FIG. 2, the microwave filter according to the invention is associated with a monopole type antenna 4 constituted by an extension of the inner core 2′ of the filter.

FIG. 3 shows a microwave filter according to the invention that is similar to the filter shown in FIG. 1 with an outer foam tube 1″ of constant cross-section and an inner bar constituted by a foam bar 2″ of variable cross-section according to the axial direction A. Here, the filter is associated with a dipole type antenna 5.

The use of the metallized foam technique enables complex coaxial structure microwave filters to be realized at low cost.

1. A coaxial structure microwave filter comprising a tube presenting a constant inner diameter and a fully metallized outer surface with, in the axial direction, a profile according to a periodic or constant function and an inner bar with a fully metallized outer profile Of following a constant or periodic function, tube and the bar being realized in foam of a metallizable material, the largest diameter of the bar being noticeably equal to the inner diameter of the tube.

2. The filter according to claim 1, wherein the periodic function is a crenelation function, the crenelations having dimensions identical from one crenelation to another.

3. Process for manufacturing, coaxial structure microwave comprising a tube presenting a constant inner diameter and a fully metallized outer surface with, in the axial direction, a profile according to a periodic or constant function and an inner bar with a fully metallized outer profile following a constant or periodic function, the tube and the bar being realized in foam of a metallizable material, the largest diameter of the bar being noticeably equal to the inner diameter of the tube in which the periodic function is realized by thermoforming the foam tube or foam bar.

4. The process of manufacturing according to claim 4, in which the foam tube or foam bar is metallized at the surface by projection or by brush.

5. The filter according to claim 1, wherein the periodic function is a crenelation function, the crenelations having dimensions different from one crenelation to another.
